(19) United States
(12) Patent Application Publication
(10) Pub. No.: US 2022/0203547 A1
(43) Pub. Date: Jun. 30, 2022

(54) SYSTEM AND METHOD FOR IMPROVING AUTOMATED ROBOTIC PICKING VIA PICK PLANNING AND INTERVENTIONAL ASSISTANCE

(71) Applicant: Plus One Robotics, Inc., San Antonio, TX (US)

(72) Inventors: Abhijit Majumdar, San Antonio, TX (US); Dan Grollman, Boulder, CO (US); Zach Keeton, San Antonio, TX (US)

(21) Appl. No.: 17/566,931

(22) Filed: Dec. 31, 2021

Related U.S. Application Data
(60) Provisional application No. 63/133,204, filed on Dec. 31, 2020.

(51) Int. Cl. B25J 9/16; G06T 1/00; G06T 7/50; G06V 10/22; G06V 10/46; G06V 20/50; G06K 9/62; G06T 7/73; B25J 13/08; B65G 59/02

(52) U.S. Cl. CPC B25J 9/1697; G06T 1/0014; G06T 7/50; G06V 10/22; B65G 59/02; G06V 20/50; G06K 9/6215; G06T 7/73; B25J 13/08; G06V 10/46

(57) ABSTRACT

The present invention relates to pick planning for robotic picking applications to improve efficiency of automated picking operations and reduce robot down time. A pick plan is computed by obtaining data of a pick scene, processing the obtained data to identify objects and determine features associated with the objects, and determining an order and pick instructions based on the features. A computed pick plan may be periodically verified by reacquiring data of the pick scene and comparing the reacquired data with previous pick scene data in order to determine if a pick plan remains appropriate or should be updated or discarded and recomputed.

### CROSS-REFERENCE TO RELATED APPLICATIONS

This application claims the benefit of U.S. Provisional Application 63/133,204, filed Dec. 31, 2020, titled “SYSTEM AND METHOD FOR IMPROVING AUTOMATED ROBOTIC PICKING BY PROVIDING INTERVENTIONAL ASSISTANCE,” which is herein incorporated by reference in its entirety.

### BACKGROUND

### Discussion of the State of the Art

Currently available systems and methods for automated moving of objects in a robotic picking environment (e.g. from a pallet, bin, container, etc. to a conveyor, pallet, bin, container, etc.) can be slow and generally inefficient. Often, robots that are tasked with moving items from a first location to a second location are given unstructured instructions. This may cause the robotic systems to perform actions that are inefficient, unnecessarily repetitive, and/or ineffective. For example, if a robot is tasked with picking boxes that are arranged on a pallet in a an organized, stacked configuration, currently available robotic systems may randomly pick boxes which may inadvertently create scenarios that make it more difficult to pick other boxes or may cause the remaining boxes to be knocked over by a robotic arm or end effector during the picking process. In other words, currently available automated picking systems may fail to consider the future ramifications of each pick, which ultimately may create additional work for the robotic system or introduce inefficiencies in the picking process which may require human intervention and/or temporary pausing of the robotic picking process until an issue is remedied.

The problem is exacerbated when objects to be picked up are not uniformly arranged, have varying shapes and sizes (e.g. not a simple, orderly, stacked configuration), and when an end effector (e.g. a gripper) has object interface dimensions which exceed the size of an object to be picked thereby resulting in the end effector overlapping and potentially picking multiple objects unintentionally. In scenarios where objects are randomly arranged in a pile, certain objects may be obstructed by one or more other objects located on top of, partially overlapping with, or located next to the obstructed object. The robot may be unable to reach an obstructed object until it is no longer obstructed, e.g., until the objects obstructing it are first moved by the robot. Alternatively, if the robot attempts to pick up an obstructed object, this may cause damage to some objects, spilling or knocking over the pile, and in certain cases objects becoming wedged and stuck, however current systems may generally fail to consider these potential pitfalls in picking an obstructed object.

Ultimately, currently available robotic picking systems may execute inefficient picking operations which may also lead to picking process interruptions such as objects on a pallet being knocked down. Current systems may allow the robotic picking system to attempt to remedy such a situation by continuing to randomly pick items which may have fallen, been knocked over or otherwise shifted during a picking operation which often may not be the most effective approach. There is a need for improvement in robotic picking that can reduce picking inefficiencies and breakdowns.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present invention overcomes the problems described above by implementing a novel pick planning approach that can improve the efficiency of robotic picking operations by determining a pick plan or pick order for each unique set of objects that are to undergo an automated robotic picking operation and avoid inefficiencies which may be associated with conventional systems which may perform picking in a random or unplanned manner. The inventive concepts disclosed herein further provide for the ability to periodically evaluate the remaining objects to be picked, verify that a previously established pick plan is still appropriate, and take appropriate action when it is deemed necessary to update the pick plan. The invention further comprises the ability for human-in-the-loop intervention to aid with automation uncertainties, such as how to handle certain objects, verifying or modifying information needed for pick planning processes, and/or providing pick planning details.

The inventive concepts are implemented via use of a vision system and/or a human-in-the-loop intervention system for picking items in a pick area. In one embodiment of the invention, the vision system captures information about the items or objects (e.g. boxes) that may be in a pick area (e.g. an area comprising a pallet of boxes). The vision system computes pick points and/or pick shapes for the one or more objects in the pick area so that a robotic picking unit can effectively pick items from the pick area. In one embodiment of the invention, the vision system may use an AI classifier to effectively identify each object that may be located in the pick area. In one embodiment, the AI system works in conjunction with a human reviewer to effectively identify pick points and/or pick shapes associated with one or more objects that may be placed on a pallet.

In one embodiment of the invention, the vision system enables specialized handling of the items on a pallet. For example, the vision system may compute pick points and/or pick shapes for an entire layer of items on a pallet and may computationally derive an order in which to pick each individual item within the layer. In other embodiments, the vision system may receive additional data from the human-in-the-loop operator to identify a layer of objects and/or objects within the layer of objects. In this manner, the robotics system is enabled to systematically pick one or more items in a manner that is efficient and less prone to error.

The following description and the annexed drawings set forth in detail certain illustrative features of the one or more aspects. These features are indicative of but a few of the various ways in which the principles of various aspects may be employed, and this description is intended to include all such aspects and their equivalents.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1A illustrates a system for improved automated robotic picking in accordance with an exemplary embodiment of the invention.

FIG. 1B illustrates an exemplary pick area and robotic picking unit in accordance with an exemplary embodiment of the invention.

FIG. 2A illustrates an exemplary vision system for use in an automated robotic picking system in accordance with an exemplary embodiment of the present invention.

FIG. 2B illustrates an exemplary top down image of a pick area with pick objects identified by pick shapes in accordance with an exemplary embodiment of the present invention.

FIG. 3A illustrates an exemplary process for computing a pick plan and providing pick instructions according to one embodiment of the invention.

FIG. 3B illustrates an exemplary process for computing a pick plan and providing pick instructions according to one embodiment of the invention.

FIG. 4 illustrates one embodiment of the computing architecture that supports an embodiment of the inventive disclosure.

FIG. 5 illustrates components of a system architecture that supports an embodiment of the inventive disclosure.

FIG. 6 illustrates components of a system architecture that supports an embodiment of the inventive disclosure.

FIG. 7 illustrates components of a computing device that supports an embodiment of the inventive disclosure.

### DETAILED DESCRIPTION

The inventive system and method (hereinafter sometimes referred to more simply as “system” or “method”) described herein provides an improved automated robotic picking system. Specifically, the inventive system disclosed here in incorporates a vision system to enhance object detection and classification, determine confidence in the object detection and classification and allow for intervention to verify and adjust object detection and classification when certain confidence criteria are not achieved. The inventive system described herein improves efficiency of a robotic picking system by reducing down-time of a robotic picking unit and reducing errors due to uncertainties in object detection and classification by allowing remote intervention to quickly resolve issues and keep the robotic picking unit actively performing picking operations.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Conceptual Architecture

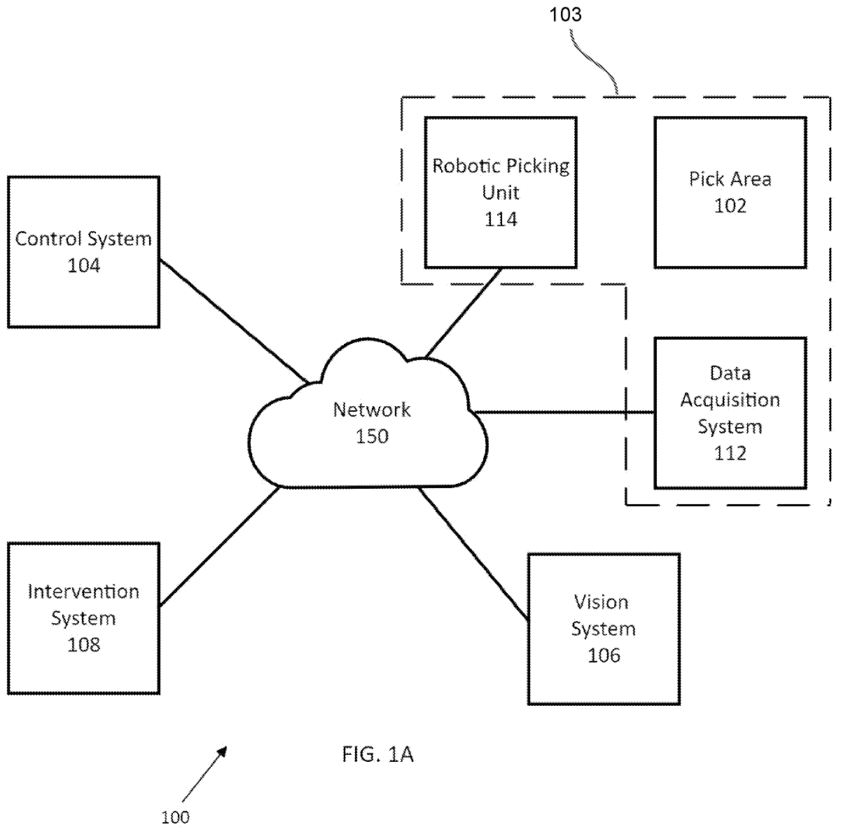

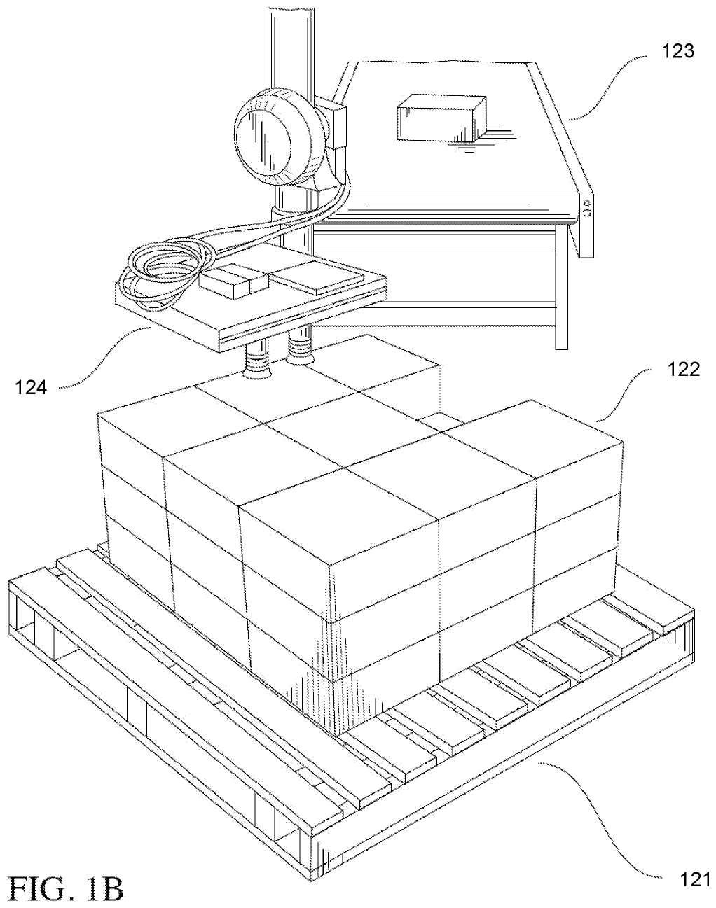

FIG. 1A illustrates a block diagram of an exemplary system for improved automated robotic picking in accordance with certain aspects of the disclosure. The exemplary system 100 may comprise a network interface 150, a control system 104, a vision system 106, a remote intervention system 108, and a robotic picking environment 103 comprising a pick area 102, a data acquisition system 112, and a robotic picking unit 114. The picking environment 103 may comprise a work area, such as that depicted in FIG. 1B that houses the robotic picking unit 114 (including, for example, a robotic arm with an end effector 124), a placement location 123 (e.g. a conveyer system), and a picking location 121 (e.g. a pallet) comprising objects 122 (e.g. boxes) to be picked and moved by the robotic picking unit 114. A variety of different picking environment 103 configurations may be used without departing from the scope of the invention, as would be apparent to a person of ordinary skill in the art, including, but not limited to the exemplary pick environment 103 described herein. For example, although depicted as a pallet and conveyor belt in this exemplary illustration the inventive techniques disclosed herein could be applied to any number of different picking environments such as those involving containers, bins, totes, or other components as would be apparent to one of ordinary skill in the art. The various computing devices described herein are exemplary and for illustration purposes only. The system may be reorganized or consolidated, as understood by a person of ordinary skill in the art, to perform the same tasks on one or more other servers or computing devices without departing from the scope of the invention.

The robotic picking unit 114 may pick objects from one portion (e.g. a pallet) of a pick area 102 and place them at another portion (e.g. a conveyor) of the pick area 102. The robotic picking unit 114 may comprise a robotic arm and an end effector 124 attached to the robotic arm. The end effector may comprise one or more grip elements such as suction cups and a mechanism to apply negative pressure or vacuum via the suction cup to enable the suction cup to temporarily attach to an object while the negative pressure is being applied. In one embodiment, the suction cups may be extendible. In other embodiments, other robotic picking units 114 and may be used, as would be apparent to a person of ordinary skill in the art, without departing from the scope of the invention, including singulation systems, etc. Moreover, a variety of different end effectors may be used without departing from the scope of the invention, including, but not limited to other types of grippers (e.g. pincers, claws, etc.), manipulation systems, etc.

The data acquisition system 112 captures data associated with the pick area 102 and/or data associated with pickable objects (e.g. boxes, bags, etc.) within the pick area 102. The data acquisition system 112 may be integrated into the pick area 102. The data acquisition system 112 may be separate from the pick area 102 but nevertheless may capture data associated with one or more portions of the pick area 102 including at least a first portion(s) of the pick area 102 (hereinafter also referred to as a pick portion(s)) and a second portion(s) of the pick area 102 (hereinafter also referred to as a placement portion(s)). The data acquisition system may be positioned such that data is acquired from above the pick area (i.e. a top-down or overhead view) such that depth data in the 3D data is indicative of the height of objects within the pick area relative to the floor or other lowest point of the pick area such as the bottom of a container, a pallet surface, etc. By way of example and not limitation, the data acquisition system 112 may include a two dimensional (2D) camera system and/or three dimensional (3D) camera system that is configured to capture data associated with at least one of the pick portion(s), the placement portion(s), and objects in the pick area (including pickable or movable objects and fixed or stationary objects). The data acquisition system 112 may comprise at least one of a three dimensional depth sensor, an RGB-D camera, a time of flight camera, a light detection and ranging sensor, a stereo camera, a structured light camera, and a two dimensional image sensor. Data acquired by a 2D camera system may be referred to as 2D data or 2D image data. Data acquired by a 3D camera system may be referred to as 3D data or depth data. In one embodiment, the data acquisition system 112 may comprise an identifier (ID) scanner. The ID scanner may be able to scan, for example, a barcode or other types of identifiers that may be associated with at least one of a pick location (e.g. a bin, container, pick tote, pallet, shelf or other storage structure, etc.), objects at the pick location (e.g. boxes, bags, containers, etc.), and a placement location (e.g. a bin, container, pick tote, pallet, shelf or other storage structure, etc.).

The control system 104 is configured to coordinate operation of the various elements of system 100 to enable the robotic picking unit 114 to move items within the pick area 102 in accordance with picking instructions. The control system 104 may interface with at least one of the other systems or units, including but not limited to the data acquisition system 112, robotic picking unit 114, vision system 106, and intervention system 108 and may serve as a control and communication system to allow the other systems and units to communicate with each other. Control system 104 may obtain information from one system, process and/or convert the information into appropriate information another system (including reformatting data such as to a standardized format), and provide at least one of the obtained information, and processed and/or converted information to another system or unit as appropriate. As an alternative to control system 104, one or more of the other systems and units may be configured as necessary in order to appropriately communicate with each other and send and receive necessary information in order to perform the concepts disclosed herein.

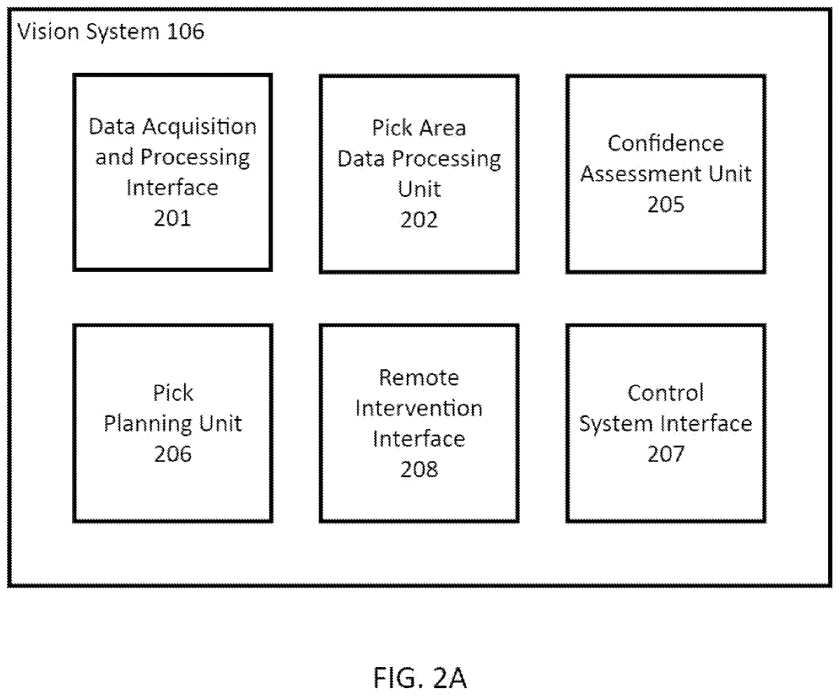

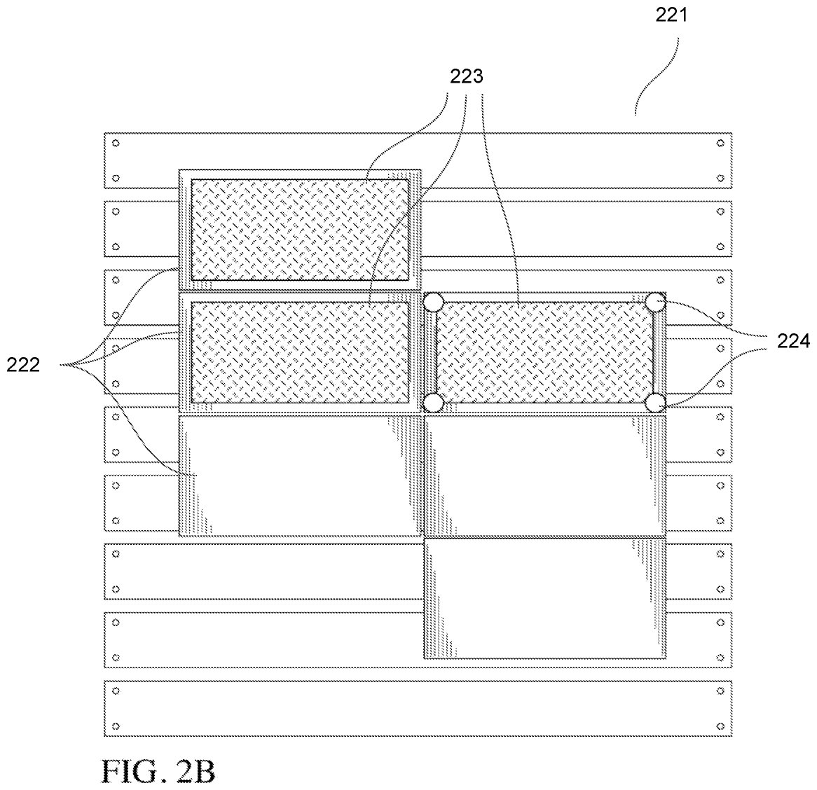

The vision system 106 obtains data of the pick area including at least data provided by the data acquisition system 112, processes the obtained data to determine characteristics of the pick area 102 and objects within the pick area 102, identifies, differentiates, and classifies pickable objects within the pick area 102, performs pick planning and end effector control planning (e.g. grip control), interfaces with remote intervention system 108 when assistance is needed to provide pick area data and obtain input for use in pick planning, and provides pick plan information such as pick instructions and end effector controls for use by the robotic picking unit 114. The vision system 106 may apply at least one algorithm to the pick area data in order to transform or extract from the pick area data, object data which can be used for computing a pick plan. For example, object data may be determined by applying an object detection algorithm to the pick area data in order to identify, differentiate, and classify the objects, establish a pick shape for each object, and determine features associated with each object that may aid in performing pick planning. Any number of algorithms may be used in order to obtain the object data necessary for pick planning. A pick shape generally comprises a surface of an object which has been detected by the vision system and can potentially be interfaced by a robotic picking unit in order to pick and/or move the object. Object features generally comprise aspects associated with object location, object size or dimensions, and object appearance such as color, patterns, texture, etc. The vision system 106 may also be configured to periodically analyze newly acquired pick area data, compare this new pick area with previous pick area data, and determine if a previously computed pick plan remains appropriate or should be adjusted or recomputed. The specifics of an exemplary vision system which could be used in the system of FIG. 1A are discussed in detail below in association with FIG. 2A-B.

The remote intervention system 108 serves to aid at least one of the vision system 106, control system 104 and robotic picking unit 114 as necessary to avoid breakdowns and handle situations of uncertainty by providing information or instructions when circumstances demand. In general, when vision system 106 encounters uncertainty associated with pick area data such as object detection, object boundaries, and object classification, the remote intervention system 108 may be called upon for object data verification or modification. For example, in a scenario where the vision system 106 is uncertain as to the differentiation of two adjacent pick objects or has determined a lower than required confidence in said differentiation, the intervention system 108 can provide additional information to the vision system 106 so that the vision system can continue with its operations. As another example, a scenario may arise where the vision system determines a lower than required confidence associated with the classification of a pick object and therefore is unable to provide an indication of how to handle the object with sufficient certainty. When this occurs, the intervention system 108 may be accessed to provide additional information to the vision system 106 so that the vision system can determine an appropriate classification and proceed with its operations. As one example, the remote intervention system 108 will provide a verification that pick shapes identified by the vision system 106 are accurate or may provide adjusted pick shape information to the vision system 106 when identified pick shapes are inaccurate. In one aspect, the intervention system 108 may provide information associated with reordering the picks in a computed pick plan for a variety of reasons such as, including but not limited to, if a determination is made that a current plan appears to include riskier picks ahead of less risky picks or if the computed pick plan appears to have overlooked an object and failed to incorporate the object into the pick plan. Additional operations of the intervention system 108 will become more apparent when described below in conjunction with the description of an exemplary vision system of FIG. 2A-B.

Network cloud 150 generally represents a network or collection of networks (such as the Internet or a corporate intranet, or a combination of both) over which the various components illustrated in FIG. 1A-B (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to clients devices or other devices in response to HTTP or other requests from clients devices or other devices. A mail server is generally capable of providing electronic mail services to various clients devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiment, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1A-B, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

### Vision System

FIG. 2A illustrates an exemplary embodiment of the vision system 106 that could be used as part of an automated robotic picking system as in FIG. 1A-B. The vision system 106 comprises a data acquisition and processing interface 201, a pick area data processing unit 202, a pick shape unit 204, a confidence assessment unit 205, a pick planning unit 206, a control system interface 207, and a remote intervention interface 208. The various computing devices described herein are exemplary and for illustration purposes only. The system may be reorganized or consolidated, as understood by a person of ordinary skill in the art, to perform the same tasks on one or more other servers or computing devices without departing from the scope of the invention. For example, any of the disclosed units, interfaces, modules, components or the like may be combined into a single element or broken down further into subelements for performing the disclosed functions without departing from the scope of the invention as would be apparent to one of ordinary skill in the art.

The data acquisition and processing interface 201 obtains data from a data acquisition system and processes the data to determine characteristics of a pick area. As discussed above, the data acquisition system may use at least 2D and/or 3D sensors or cameras to obtain data about the pick area, which is referred to herein as pick area data. The 2D and 3D pick area data may be obtained as separate data sets (i.e. a 2D data set, a 3D dataset) or in a combined format (i.e. a 2D/3D dataset) depending on the data acquisition system being used. The data acquisition and processing interface 201 may obtain the pick area data and perform at least one of transmitting the pick area data to other vision system components in the same form as it was received, converting the pick area data into a format suitable for processing by at least one other vision system component, and converting the pick area data into a standardized format. In some scenarios, only 2D data may be obtained. In some scenarios, only 3D data may be obtained. In some scenarios, both 2D and 3D data may be obtained.

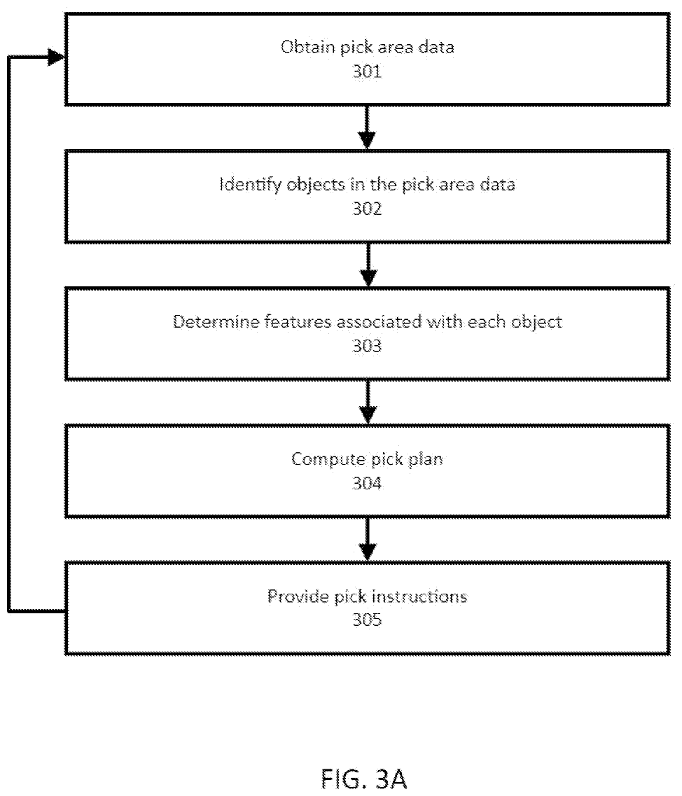

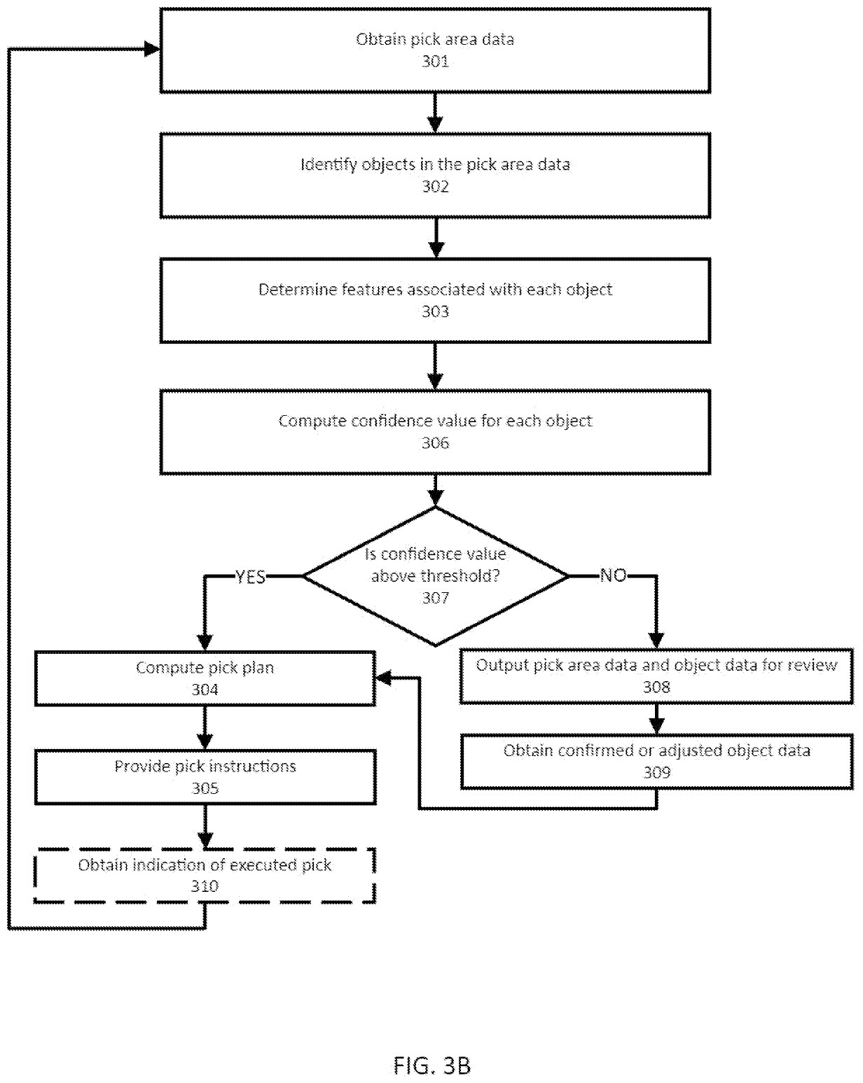

The pick area data processing unit 202 processes the pick area data to at least one of identify and differentiate pickable objects in the pick area data, determine a pick shape for at least one of the objects, and determine at least one feature associated with each object. Additional detailed discussion of the pick area data processing is described in association with FIGS. 3A-3B below.

The pick area data processing unit 202 may perform object detection in order to identify, differentiate and classify objects in the pick area data. Object detection may be performed using an algorithm such as such as You Only Look Once (YOLO), Region-based Convolutional Neural Networks (R-CNN), Fast R-CNN, Faster R-CNN, Histogram of Oriented Gradients (HOG), Region-based Fully Convolutional Network (R-FCN), Single Shot Detector (SSD), Spatial Pyramid Pooling (SPP-net), as well as other image processing and computer vision techniques including but not limited to image registration, image segmentation, plane segmentation, template matching, edge detection, feature detection, and planar and linear transformations. This list is not intended to be limiting and any suitable object detection algorithm may be employed without departing from the scope of the invention as would be apparent to one of ordinary skill in the art. Object detection may comprise identifying a pick shape for each object, where the pick shape generally corresponds to a surface of the object capable of being interfaced by an end effector of a robotic picking unit. The pick area data processing unit 202 may perform object classification which may comprise classifying objects according to object class (e.g. box, bag, envelope, etc.). The pick area data processing unit 202 may perform object handling categorization based on how a robotic picking unit should handle each object. For example, objects may be categorized as pick objects to be moved to a placement location for later distribution, rejected objects which the system is rejecting due to an inability to determine what the object is and where it should be moved to, and discard objects which the system identifies as waste or trash. Object handling categorization may be performed independently or may be based on object classification, such as categorizing recognized, familiar or known object classes (e.g. boxes, bags, envelopes, etc.) as pick objects and unknown or unrecognized objects as rejected objects requiring additional insight to determine appropriate handling.

The pick area data processing unit 202 may determine various object features from the pick area data for use in computing a pick plan. Exemplary features include, but are not limited to, two dimensional (2D) object location, three dimensional (3D) object location, object size, object shape (e.g. circular, spherical, cylindrical, rectangular, cubical, etc.), an amount of obstruction associated with a surface of the object, a relative location of each object with respect to other objects, proximity to or distance from other objects, object color, a pattern associated with the object, a texture associated with the object, object weight, object material, object class (e.g. box, bag), object rigidity/deformability or likelihood an object will maintain its observed size and shape during a picking operation, a risk score associated with picking the object, information obtained from object indicia, and estimated ease or difficulty of placing an object at a placement location.

The pick area data processing unit 202 may determine confidence information (e.g. a confidence value) for each object and/or each of the object detection, object classification, pick shape, and one or more object features. The confidence information may generally represent a degree of certainty associated with at least one of the object detection, object classification, pick shape, and one or more object features. The confidence information may be relayed to the confidence assessment unit for further analysis as discussed below.

The pick area data processing unit 202 may perform a comparison of previously acquired pick area data with newly acquired (or updated) pick area data in order to evaluate if a previously computed pick plan remains appropriate in light of the newly acquired pick area data. For example, after an object has been moved (e.g. picked and placed according to a pick plan) or after a set amount of time has elapsed, new pick area data may be obtained which may reflect a change in the pick area. The pick area data processing unit 202 may compare the new pick area data with previous pick area data in order to determine if any change in the pick area data is expected or unexpected. Expected changes may comprise a change in the pick area data associated with a location where an object was to be picked and/or moved in accordance with a previously computed pick plan. Expected changes may comprise a computed expected change indicating an amount of change anticipated or certain characteristics expected to change at the location where an object was to be picked and/or moved. Unexpected changes may comprise changes in the pick area data associated with a location(s) other than a location where an object was to be picked and/or moved in accordance with a previously computed pick plan or changes that do not match or differ from the expected change by a threshold amount. When unexpected changes are determined, the pick area data processing unit 202 may repeat one or more of the above mentioned processing steps such that new, up to date object data can be computed and provided for pick planning purposes.

The confidence assessment unit 205 obtains confidence information associated with at least one of the object detection, object classification, pick shape, and one or more object features as determined above and determines, based on the confidence information, if interventional assistance is warranted or if the system may proceed with further operations such as pick planning without intervention. The confidence assessment unit 205 may compare confidence values with a threshold to determine if intervention is required. If confidence values are above a threshold, the confidence assessment unit may provide an indication of such and the pick planning unit 206 may be instructed to proceed with computing a pick plan. If one or more confidence value(s) are below a threshold, the confidence assessment unit 205 may trigger a request for assistance, such as from the remote intervention system 108.

The remote intervention interface 208 interfaces with a remote intervention system to aid the pick area data processing unit 202 when the confidence assessment unit 205 determines that intervention is warranted (e.g. confidence values are below a threshold). The remote intervention interface 208 may provide information to a remote intervention system, such as the pick area data (2D and/or 3D data) and/or determined object data, and obtain information such as a verification of the object data, modification to the object data, and/or new object data as provided from the remote intervention system. In one aspect, remote intervention interface 208 may obtain pick plan information which may supplement or supersede pick planning as determined by pick planning unit 206 discussed below.

The pick planning unit 206 obtains at least one of pick area data, object data, and remote intervention information, and computes a pick plan for picking and/or moving objects. A pick plan may comprise at least one of a number of planned picks, a pick order, and end effector controls (e.g. grip control) for a robotic picking unit to execute the pick plan. The pick planning unit 206 may determine an order to pick and move pick objects that is least likely to cause disruption to the objects. A variety of different pick orders may be used including, but not limited to, a top to bottom, outside to inside pattern, a top to bottom, inside to outside pattern, a side to side pattern across a top layer, a top to bottom pattern along one side, a top to bottom pattern around a perimeter of the objects, etc. however other alternatives are possible, depending on the particular circumstances. The pick planning unit 206 may determine at least one of pick coordinates for each object in a pick plan, pick instructions for each object in a pick plan, and end effector controls necessary to achieve the computed pick plan. For example, in some scenarios the size of an end effector may be larger than a pick object, and using the entire surface of the end effector to pick an object may result in the end effector overlapping with multiple adjacent objects. In these circumstances the pick planning unit 206, may determine a location and orientation of the end effector that will result in only the target pick object being picked. In addition or the alternative, the pick planning unit 206 may also control the end effector so that only a portion of the end effector is used for picking the target pick object. For example, in the scenario where the end effector is an array of grip elements, such as suction cups, the pick planning unit 206 may determine an appropriate selection of grip elements from this array so that only those grip elements coming in contact with the target pick object are activated during the pick process for that target object. Alternatively, based on the object data, the pick planning unit 206 may determine that picking two or more objects simultaneously would be beneficial, efficient, and not expected to cause disruption to other pick objects. In this scenario, pick instructions, pick coordinates and/or end effector controls may comprise information allowing a plurality of objects to be picked simultaneously. Pick planning, or computing a pick plan, is discussed in more detail in association with FIG. 3A-3B, the steps of which may be performed by the pick planning unit 206.

The control system interface 207 obtains information from at least the pick planning unit 206 and relays this information to a control system, such as control system 104 in FIG. 1A, which in turn provides necessary information to a robotic picking unit for executing robotic picking operations. In addition, the control system interface 207 may obtain and provide information to and from a control system as part of ongoing control of a robotic picking unit. For example, once a pick plan is established, the picking process may begin by picking and placing a first object followed by a pick area change check by the pick area data processing unit 202 as described above to ensure that the pick scene has only changed as expected and that the pick plan can proceed, or alternatively that the pick scene has changed unexpectedly and the automated picking in accordance with a previously computed pick plan should be interrupted so that new analysis and new pick plan computation can be performed.

### Process for Computing Pick Plans and Providing Pick Instructions

FIG. 3A illustrates an exemplary process for computing a pick plan and providing pick instructions for automated robotic picking of objects in accordance with one embodiment of the invention. The process comprises obtaining data of a pick area 301, identifying objects in the pick area data 302, determining features associated with each identified object 303, computing a pick plan 304, and providing pick instructions 305. The order of steps is exemplary and one or more steps could be performed simultaneously and/or in a different order than depicted as would be recognized by one of ordinary skill in the art. These steps may be performed by, or in association with, a vision system such as vision system 106 as described above.

At step 301, the process comprises obtaining pick area data. The pick area may be an area associated with robotic picking such as an area of a pick cell or work cell as described above with respect to FIGS. 1A-1B. The pick area may comprise a pallet, pick tote, bin, container or the like comprising objects to be picked and/or moved from the pallet, pick tote, bin, container or the like to another location. The pick area data may comprise 2D and/or 3D data. The 2D data may comprise 2D image data such as 2D color image data. The 3D data may comprise 3D depth data. The pick area data may be obtained from a data acquisition system associated with the pick area, such as the data acquisition system 112 as described in FIGS. 1-2 above.

At step 302, the process comprises identifying objects in the pick area data. Identifying objects may comprise differentiating each object from other objects and defining a pick shape for each object. Identifying or differentiating may comprise applying an object detection algorithm to the obtained 2D and/or 3D data, such as You Only Look Once (YOLO), Region-based Convolutional Neural Networks (R-CNN), Fast R-CNN, Faster R-CNN, Histogram of Oriented Gradients (HOG), Region-based Fully Convolutional Network (R-FCN), Single Shot Detector (SSD), Spatial Pyramid Pooling (SPP-net). This list is not intended to be limiting and any suitable object detection algorithm may be employed as would be apparent to one of ordinary skill in the art. Identifying objects may comprise computing a total number of objects detected.

Identifying objects may comprise computing or defining a pick shape for each object where the pick shape is indicative of a target portion of the object which may be referred to as a target pick portion. The target portion of the object may be associated with an area of the object to be interfaced by an end effector of the robotic picking unit. The pick shape or target portion of the object may be a shape that corresponds to the boundaries of the object, a shape spanning an area smaller than the boundaries of the object, a shape that is different than the shape of the object, a shape centered at the center of the object, a shape centered at a location away from the center of the object, and a shape that extends outside the boundaries of the object in at least one dimension. For example, as depicted in FIG. 2B which shows an exemplary 2D image taken from above a group of pick objects 222 sitting on a pallet 221, pick shapes 223 may be rectangles with edges and corners 224 that generally correspond to the boundaries of each object as determined from the pick area data. Other shapes may also be used such as other polygon shapes or circular shapes as is necessary to define shapes appropriate for picking of the objects to be picked and/or moved. Any pick shape may be used as is necessary for a given object and the pick shape need not match the shape of the object to be picked. For example, a square pick shape may be defined for a rectangular object and vice versa, or a circular pick shape may be defined for square or rectangular pick objects and vice versa. Other variations of pick shapes may be used as would be apparent to one of ordinary skill in the art. In one aspect, the pick shape may comprise a shape that spans two or more objects. With a pick shape that spans two or more objects, a robotic picking unit may be instructed to simultaneously pick and/or move multiple objects. A pick shape that spans multiple objects may be determined by first determining a pick shape for each object independently, then combining two pick shapes, such as the pick shapes of two adjacent objects, in order to generate a single combined pick shape. This may be done as part of the identifying or defining pick shapes or may be done as part of the pick plan computing step (step 304) as discussed below.

Identifying objects may comprise classifying objects according to object class (e.g. box, bag, envelope, etc.). Identifying objects may comprise performing object handling categorization associated with what action should be taken for each object including how a robotic picking unit should handle objects. For example, objects may be categorized as pick objects to be moved to a placement location for later distribution, discard objects which the system identifies as waste or trash, and rejected objects which are associated with uncertainty regarding how to handle the object (e.g. uncertainty of what the object is and how and where it should be moved). Rejected objects could be any object an automated analysis system is unsure how to handle and requires review by a human to decide an appropriate handling of the object. This may include objects such as those missing a mailing label, boxes with minor damage, unfamiliar or foreign objects which the system is unsure how to handle, and the like. Discard objects may include objects that the system has determined should be disposed of such as slip sheets, structural support items or other items included in a group of objects which are no longer needed, ripped or torn bag of food or other material, or other severely damaged object(s) which should not be placed for distribution. Alternatively, objects such as slip sheets, structural support items and the like may be categorized as recycle or reuse objects depending on the nature of the item and the condition of the item. The object handling categorizations of pick object, rejected object, discard object, and recycle or reuse object are merely exemplary and other categorizations could be used without departing from the scope of the invention. For example, pick objects may be further classified based on their determined placement location such as a first group of pick objects to be placed at a first location, a second group of pick objects to be placed at a second location, and so on. In one aspect, some objects may be classified as pick objects and all other objects as ignore objects such that only the classified pick objects are picked and moved while ignore objects are left unpicked by a robotic picking unit. Other classifications and combinations thereof may also be used as part of the classification process as would be apparent to one of ordinary skill in the art.

At step 303, the process comprises determining features associated with the identified objects. Features may comprise at least one of observable intrinsic features, extrinsic features, and unobservable intrinsic features. Observable intrinsic features may comprise at least one of object size, object shape (e.g. circular, spherical, cylindrical, rectangular, cubical, etc.), object class (e.g. box, bag), object color, a pattern associated with the object, a texture associated with the object, information obtained from object indicia, etc. Extrinsic object features may comprise two dimensional (2D) object location, three dimensional (3D) object location, an amount of obstruction associated with a surface of the object, a relative location of each object with respect to other objects, proximity to or distance from other objects, etc. Unobservable intrinsic object features comprise at least one of object weight, object material, object rigidity/deformability or likelihood an object will maintain its observed size and shape during a picking operation, a risk score associated with picking the object, estimated ease or difficulty associated with placing the object, etc. The features may be determined from 2D pick area data, 3D pick area data, or a combination of the 2D and 3D pick area data. Observable intrinsic features may be determined directly from pick area data and/or the object detection algorithm. For example, pick area data may be analyzed to determine average color in a given area associated with each object. In one aspect, feature level information obtained from object detection, such as output of a neural network may provide the observable intrinsic features. Extrinsic object features may be computed from analysis of the pick area data as a whole. For example, for each detected object, a relative location from the edges or from other objects may be computed based on where in the full pick area data set (e.g. a 3D point cloud), data associated with each object is located. Unobservable intrinsic object features may be determined more theoretically such as based on past experience or past interactions. For example, a database of past interactions or a learned or trained model associated with past interactions may be used to predict unobservable intrinsic objects such as deformability or risk associated with each object.

At step 304, the process comprises computing a pick plan based on at least one of the identifying objects step 302 (e.g. pick shapes) and at least one feature of the determining features step 303. A computed pick plan may comprise at least one of a pick sequence or order in which each object will be picked, instructions or pick coordinates for each pick, and end effector controls associated with each planned pick. A pick plan may be computed based on a single feature or a combination of features. Computing a pick plan may comprise use of a feature hierarchy. For example, a pick plan may be computed that prioritizes 3D object location first, then 2D object location. An exemplary pick plan following this hierarchy may comprise a top to bottom, outside to inside pick plan which aims to pick the highest objects first working from an outer perimeter of the collective group of objects towards a center point of the collective group of objects. The feature hierarchy may comprise any number of features in any order. The feature hierarchy may comprise two or more features being assigned the same ranking, weighting or prioritization. Any hierarchy of the above listed features, among others, may be used as would be apparent to one of ordinary skill in the art. Computing a pick plan may be performed automatically by a processor or computing device or may be performed via an intervention system, such as the one described above in association with FIG. 1, wherein a user may indicate the pick plan via input through the intervention system.

Computing a pick plan may comprise identifying a target portion of objects. For example, after identifying objects as discussed above in step 302, a subset of objects may be identified, defined or selected. This identifying, defining or selecting of a subset or target portion of objects may be based on object features. For example, a target portion or subset of objects may comprise a group of objects forming the top layer of the identified objects, a group of objects arranged along one side of the identified objects, a group of objects forming a perimeter of the identified objects, a group of objects forming a flat region among the identified objects, a group of objects located in proximity to the center of the identified objects, a group of objects associated with a particular height range, a group of objects having the same shape and/or size, a group of objects having the same color, a group of objects having the same amount of obstruction, etc. Other subsets or target portions of objects may be identified or selected as without departing from the scope of the invention as would be recognized by a person of ordinary skill in the art. A pick plan may be computed only for the target portion or subset of objects. A pick plan may be computed for one or more target portions or subsets of objects.

A variety of different methodologies may be used to identify the target portion(s) of objects by processing the 3D data, as would be apparent to a person of ordinary skill in the art, which are considered to be within the scope of the invention. In general, this may comprise defining a metric in 3D space, applying the metric to a 3D point cloud, and accepting or rejecting points (and their corresponding objects) based on the metric value. For example, to identify a top layer of objects, a 3D point cloud representing the pick area and a pile of objects may be analyzed to identify, for each of a plurality of 2D locations, the highest point in the 3D cloud at the corresponding 2D location and identify the corresponding object(s) associated with this point. A group of objects arranged along one side of the identified objects may be determined by analyzing the 3D point cloud to determine the minimum and maximum horizontal or 2D coordinates and then identifying objects which share or are in close proximity to a common coordinate along one dimension. A group of objects forming a perimeter of the identified objects may be determined by analyzing the 3D point cloud to determine a central point associated with the pile of objects, determine a distance each object is from the central point, and identify objects having the greatest distances from the central point as those forming the perimeter. This approach may also be used to determine objects along one side since the perimeter is the collection of objects around each side of a pile or group of objects. A group of objects forming a flat region among the identified objects may be determined by analyzing the 3D point cloud as a function of 2D or horizontal position in or to compute a variation in height across the pile of objects and corresponding pick area data and then identify the objects associated with lower variations in height as those forming a flat region(s). A group of objects located in proximity to the center of the identified objects may be determined by identifying 2D and/or 3D coordinates associated with a point that is at or near to the center of the collective group of identified objects and then determining which objects are within a threshold distance of the center coordinates. This may comprise computing from the object coordinates and the center coordinates, a distance for each object relative to the center coordinates. A group of objects associated with a particular height range may be determined by analyzing the 3D point cloud in order to determine which objects are associated with 3D depth data that is within the particular height range. Obstruction of an object may be determined using 3D object position information in order to determine that one object is occluded, at least in part, by one or more other objects, and rejecting the occluded object from being in the target portion of objects based on the determined occlusion. This list of methodologies is exemplary and other methodologies may be used in identifying a target portion of objects without departing from the scope of the invention as would be apparent to one of ordinary skill in the art.

Computing a pick plan may comprise identifying pick shapes as discussed above. Computing a pick plan may comprise computing a pick plan based on the established pick shapes from step 302. Computing a pick plan may comprise modifying the established pick shapes from step 302. For example, if a pick shape has been identified for each of two adjacent objects, computing a pick plan may comprise combining the two pick shapes into one shape representative of where an end effector of a robotic picking unit should interface in order to pick both objects simultaneously. Other forms of modification may comprise relocating or repositioning pick shapes, adjusting the size of the pick shapes, adjusting the shape of the pick shape, adjusting at least one edge or boundary of the pick shape, deleting or removing a pick shape, adding a new pick shape, and replacing a pick shape with a new pick shape such as by redrawing or redefining the pick shape for an object. The adjusting as described herein may comprise changing the location of pick shape points such as points 224 overlaid on a 2D image of the pick area as in FIG. 2B).

Computing a pick plan may comprise performing at least one simulation associated with how the pick scene will change for a computed pick plan. Simulation may be performed in a variety of ways as would be apparent to one of ordinary skill in the art. For example, a plurality of pick plans may be computed, then a simulation performed for each pick plan in order to evaluate the outcomes of each, identify potential pitfalls or shortcomings (e.g. do certain pick plans contain more riskier picks than others), and/or rate or score each computed pick plan. A pick plan to implement may be chosen based on the rating or score determined from the simulation(s). Alternatively, simulation may be performed on a pick by pick basis as part of computing a pick plan. For example, starting with determining a first pick, each potential next pick is simulated in order to identify a preferred next pick (e.g. the least risky pick, the pick which leaves the remaining pick scene with the fewest potential pitfalls or subsequent risky picks, etc.) which may then be accepted as the first pick. Then the same process repeats to determine a second pick using the available information about the remaining potential next picks in addition to any new potential next picks made available due to the accepted previous pick(s), and so on for determining third, fourth, etc. picks in the pick plan. Computing a pick plan may comprise simulating the effects of picking certain objects so that obstructed objects become unblocked or unobstructed and if that would affect a preferred pick order/plan.

At step 305, the process comprises providing pick instructions based on the computed pick plan. The pick instructions may be provided to a robotic picking unit associated with the pick area. The pick instructions may comprise instructions to perform the entirety of the computed pick plan. The pick instructions may comprise instructions to perform a portion of the computed pick plan. For example, pick instructions may be provided on a pick by pick basis as the computed pick plan is executed by a robotic picking unit such that the robotic picking unit is being provided instructions for one picking action at a time.

FIG. 3B illustrates an exemplary process for computing a pick plan and providing pick instructions for automated robotic picking of objects in accordance with one embodiment of the invention. The process comprises obtaining data of a pick area 301, identifying objects in the pick area data 302, determining features associated with each identified object 303, computing a pick plan 304, providing pick instructions 305, computing a confidence value for each object 306, comparing the confidence value to a threshold 307, outputting pick area data and object data for review 308, obtaining and optionally obtaining an indication of an executed pick 310. These steps may be performed by, or in association with, a vision system such as vision system 106 as described above.

In this exemplary process, steps 301-305 are implemented as described above with respect to FIG. 3A, along with additional intermediate steps 306-307, optionally steps 308-309 as discussed below, and repetition of one or more steps as discussed below.

At step 306, the process comprises computing a confidence value associated with the results of at least one of the identifying objects step (e.g. the determined pick shapes) and the determining features step. A separate confidence value may be computed for each aspect of the identifying and/or feature determination steps. For example, a first confidence value may indicate the degree of certainty that a determined pick shape accurately represents the associated object, a second confidence value may indicate a degree of certainty that a first determined feature associated with an object is accurate, a third confidence value may indicate a degree of certainty that a second determined feature associated with an object is accurate, and so on. Alternatively, a single confidence value may be computed that is representative of the degree of certainty for a plurality of the identifying and feature determination aspects. A confidence value may be based on at least one of the object detection algorithm results, a history of pick interactions and pick outcomes for various pick objects and pick locations (e.g. learned from a database), and human input or interaction. In addition or alternatively, a confidence value may be based on holistic pick scene considerations, such as the total number of objects and/or their placement may impact confidence values. For example, each object may be associated with a high confidence value, however due to at least one of a large number of objects, their relative placements/orientations, and amount of obstruction, the holistic pick scene may have a lower confidence value overall. This may be reflected by computing the holistic confidence value for later evaluation/comparison and/or by applying some adjustment to the confidence value of each object in order to account for overall pick scene confidence.

At step 307, the process comprises comparing the computed confidence value(s) with a threshold value in order to determine if intervention is necessary prior to computing a pick plan in step 304. If the computed confidence value(s) exceed the threshold value, the process continues to steps 304-305 as described in detail above. If the computed confidence value(s) are below the threshold value, the process proceeds to steps 308-309 in order to obtain additional input prior to computing a pick plan. Alternatively, step 304 may occur prior to step 307 (before or after step 306) in order to compute a pick plan which itself may be associated with a confidence value that can be evaluated at step 307 to determine if confidence in the computed pick plan exceeds a threshold amount. If the threshold is satisfied, the computed pick plan may be implemented as computed. If the threshold is not satisfied, the computed pick plan may be output and follow the pathway of steps 308-309 in order to obtain interventional input for the computed pick plan.

At step 308, the process comprises outputting at least one of the obtained pick area data, object data, and computed pick plan, where the object data may comprise at least one of data associated with the object detection (e.g. pick shapes, classification) and determined object features as discussed above. The obtained pick area data and object data may be output to a remote intervention system such as the one described above in association with FIG. 1. As an alternative to outputting the data, an indication that intervention is needed may be sent to a remote intervention system through which a user can view and interact with at least one of the pick area data, object data, and computed pick plan.

At step 309, the process comprises obtaining at least one of confirmation of the object data (e.g. pick shapes, classification, features) and computed pick plan, and a modification to at least one of the object data and pick plan in the event that there is a need for adjustment of any of the object data or pick plan information. Once the object data and/or pick plan has been reviewed and necessary confirmation or modification of object data and/or pick plan has been obtained, the process continues to step 304 above or step 305, as appropriate, these steps being implemented as described above.

At step 310, the process optionally comprises obtaining an indication of an executed pick. Alternatively, instead of obtaining an indication, the process comprises a threshold delay or wait time such as an estimated amount of time expected for a robotic picking unit to execute the next pick in accordance with the instructions.

After a pick has occurred (e.g. after receiving an indication that a pick was executed, after waiting some duration of time), at least one step in the process may be repeated in order to verify the previously computed pick plan remains appropriate, update or adjust the pick plan, or compute a new pick plan. For example, after a pick has occurred, an updated set of pick area data (or second pick area data) may be obtained and compared with the previous (or first) pick area data. The updated pick area data may be the same as the pick area data described above, and may be 2D data and/or 3D data. Comparing the updated pick area data with previous pick area data may comprise computing an amount of difference or similarity between the two data sets. Computing an amount of difference or similarity between the two data sets may comprise accounting for an area within the data sets where an object was picked. For example, in computing an amount of difference or similarity, the area associated with a location where an object was picked may be excluded from the calculation. Alternatively, an expected amount of change in the area where the object was picked may be determined and the comparison account for this expected change in the calculation. A variety of methodologies may be used to compute the amount of difference or similarity between the two data sets as would be apparent to one of ordinary skill in the art. By way of example, and not limitation, image processing techniques such as image subtraction and/or image correlation may be used to determine the amount of difference or similarity between data sets. These approaches may account for specific locations within the data set where change is expected due to a pick being performed and the image subtraction or correlation may determine if the changes and/or similarities are occurring at the location(s) in the data associated with an object(s) that was/were picked or if the changes and/or similarities are occurring at locations outside of where an object(s) was/were picked. Additionally, filtering and/or smoothing approaches may be applied in order to account for noise as part of the image processing and difference/similarity computations. If the amount of difference or similarity satisfies an expected criteria (e.g. meets a threshold) then a determination may be made that the computed pick plan remains valid and picking operations may continue as previously planned. This may comprise proceeding to step 305 from 301 on subsequent iterations of the process when pick instructions are being provided on a pick by pick basis. As an alternative, if a plurality of pick instructions had been previously provided in association with the previously computed pick plan, the next step after step 301 and the comparison discussed above may be providing an indication to proceed with the previous instructions. If the amount of difference or similarity fails to satisfy the expected criteria (e.g. the threshold is not met) then a determination may be made that the computed pick plan is no longer valid and at least one of steps 302 through 305 and optionally at least one of steps 306 through 309 should be repeated in order to determine a new, updated pick plan.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

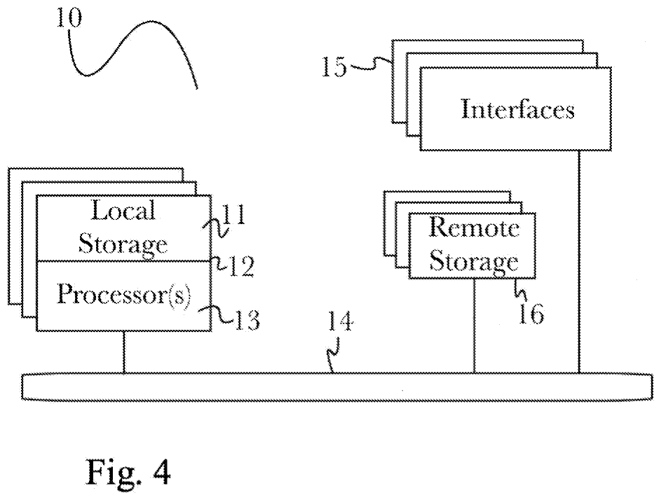

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

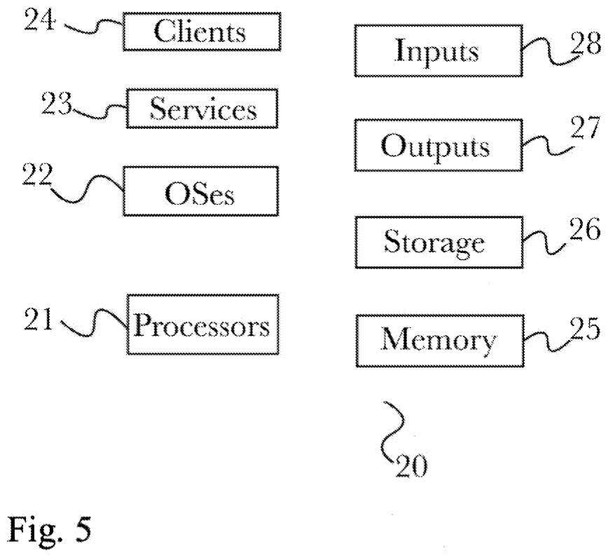

In some embodiments, systems may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

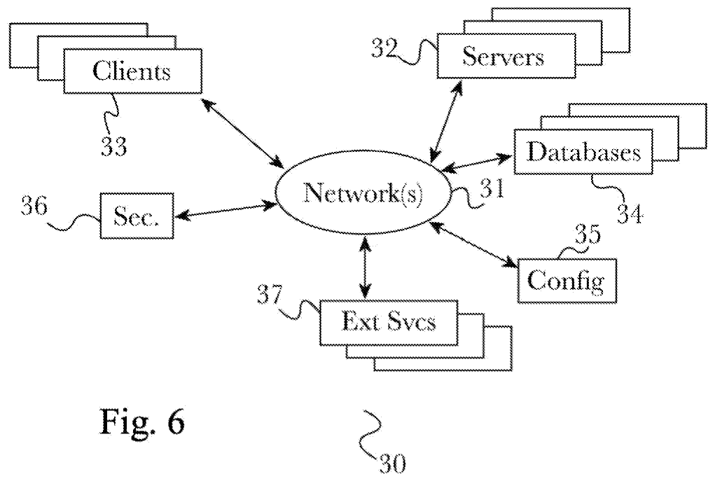

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 6. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

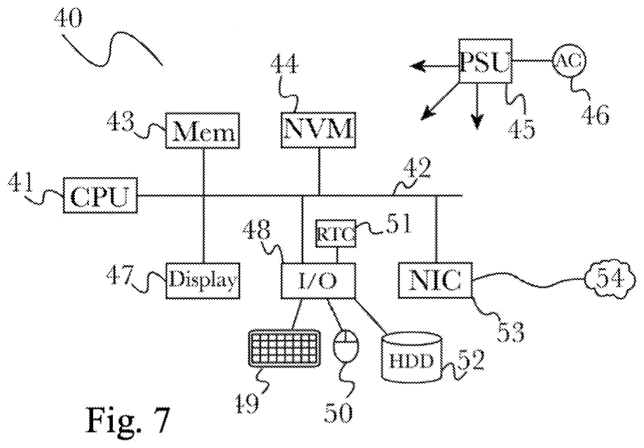

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computer implemented method for computing a pick plan and providing pick instructions to a robotic picking unit associated with a pick area, the computer implemented method comprising:
obtaining pick area data, the pick area data comprising image data and depth data associated with the pick area, the image data and depth data comprising data associated with one or more objects located at least partially in the pick area, the one or more objects capable of being at least one of picked and moved by the robotic picking unit associated with the pick area, the image data obtained from a camera system associated with the pick area, the image data comprising two dimensional image data, the depth data comprising three dimensional depth data;
automatically identifying, in the pick area data, a plurality of objects able to be at least one of picked and moved, wherein the identifying comprises differentiating each object from other objects and defining a pick shape associated with each object, wherein the pick shape is indicative of a target pick portion of the object, wherein the target pick portion of the object is associated with an area of the object to be interfaced by an end effector of the robotic picking unit;
determining at least one feature associated with each object based on the pick area data;
computing a pick plan for at least one of picking and moving one or more of the objects, the pick plan computed based on the pick shape and at least one of the features;
providing pick instructions associated with the computed pick plan to a robotic picking unit, wherein the pick instructions comprise instructions to at least one of pick and move at least one object thereby enabling the robotic picking unit to perform picking operations in accordance with the computed pick plan.

2. The computer implemented method according to claim 1, further comprising obtaining second pick area data, the second pick area data comprising at least one of second image data and second depth data associated with the pick area, the second image data comprising two dimensional image data, the second depth data comprising three dimensional depth data; computing an amount of similarity or an amount of difference between the pick area data and the second pick area data by comparing the second pick area data with the pick area data; and determining, based on the amount of similarity or amount of difference, whether to allow the robotic picking unit to continue with pick instructions based on the computed pick plan or to compute a second pick plan.

3. The computer implemented method according to claim 2, wherein the obtaining second pick area data is performed in response to the robotic picking unit executing at least a portion of the pick instructions associated with the computed pick plan.

4. The computer implemented method according to claim 2, further comprising obtaining an indication that the robotic picking unit executed at least a portion of the pick instructions, wherein the obtaining second pick area data is performed in response to the obtaining an indication that the robotic picking unit executed at least a portion of the pick instructions.

5. The computer implemented method according to claim 2, wherein the computing an amount of similarity or an amount of difference comprises excluding a portion of the pick area data and second pick area data from the comparing, the excluded portion associated with the pick shape of an object that was moved in accordance with the computed pick plan.

6. The computer implemented method according to claim 2, wherein the computing an amount of similarity or an amount of difference comprises accounting for an expected change in a portion of the pick area data and second pick area data during the comparing, the portion associated with the pick shape of an object that was moved in accordance with the computed pick plan.

7. The computer implemented method according to claim 2, wherein the computed pick plan comprises a plurality of picks in a planned sequence, wherein the allowing the robotic picking unit to continue comprises providing pick instructions associated with the next pick in the planned sequence.

8. The computer implemented method according to claim 1, wherein the computed pick plan comprises at least one planned pick associated with picking two or more objects simultaneously, wherein the pick instructions comprise instructions to control an end effector of the robotic picking unit to at least partially span two or more objects.

9. The computer implemented method according to claim 8, wherein the two or more objects are adjacent to each other.

10. The computer implemented method according to claim 1, wherein computing a pick plan comprises identifying a target portion of the plurality of objects.

11. The computer implemented method according to claim 10, wherein computing the pick plan comprises computing a pick plan only for the target portion of objects.

12. The computer implemented method according to claim 1, wherein differentiating comprises applying an object detection algorithm to the obtained image data and depth data.

13. The computer implemented method according to claim 1, wherein the pick shape associated with each object comprises at least one of a shape that corresponds to the boundaries of the object, a shape having an area smaller than the boundaries of the object, a shape that is different than the shape of the object, a shape centered at the center of the object, a shape centered at a location away from the center of the object, and a shape that extends outside the boundaries of the object in at least one dimension.

14. The computer implemented method according to claim 1, further comprising computing at least one confidence level associated with at least one of each defined pick shape and each feature associated with each object and obtaining remote intervention data when the confidence level is below a threshold value.

15. The computer implemented method according to claim 14, wherein the remote intervention data is obtained from a remote intervention system and comprises at least one of verification of at least one defined pick shape, modification of at least one defined pick shape, removal of at least one defined pick shape, addition of at least one newly defined pick shape, and modification of the computed pick plan.

16. The computer implemented method according to claim 1, wherein the pick plan comprises at least one of an order in which each of the identified objects should be picked and/or moved and pick information for each object, the pick information indicating at least one of pick coordinates and end effector functions for use in control of the robotic picking unit.

17. The computer implemented method according to claim 1, wherein the at least one feature associated with each object comprises at least one of two dimensional object location, three dimensional object location, object size, an amount of obstruction associated with a surface of the object, a relative location of each object with respect to other objects, proximity to or distance from other objects, object color, object class, and information obtained from object indicia.

18. The computer implemented method according to claim 1, wherein the camera system comprises at least one of a three dimensional depth sensor, an RGB-D camera, a time of flight camera, a light detection and ranging sensor, a stereo camera, a structured light camera, and a two dimensional image sensor.

19. A system for computing a pick plan and providing pick instructions to a robotic picking unit associated with a pick area, the computer implemented method comprising:
control circuitry configured to perform a method comprising:
obtaining pick area data, the pick area data comprising image data and depth data associated with the pick area, the image data and depth data comprising data associated with one or more objects located at least partially in the pick area, the one or more objects capable of being at least one of picked and moved by the robotic picking unit associated with the pick area, the image data obtained from a camera system associated with the pick area, the image data comprising two dimensional image data, the depth data comprising three dimensional depth data;
automatically identifying, in the pick area data, a plurality of objects able to be at least one of picked and moved, wherein the identifying comprises differentiating each object from other objects and defining a pick shape associated with each object, wherein the pick shape is indicative of a target pick portion of the object, wherein the target pick portion of the object is associated with an area of the object to be interfaced by an end effector of the robotic picking unit;
determining at least one feature associated with each object based on the pick area data;
computing a pick plan for at least one of picking and moving one or more of the objects, the pick plan computed based on the pick shape and at least one of the features;
providing pick instructions associated with the computed pick plan to a robotic picking unit, wherein the pick instructions comprise instructions to at least one of pick and move at least one object thereby enabling the robotic picking unit to perform picking operations in accordance with the computed pick plan.

20. A non-transitory computer readable medium comprising instructions that, when executed by a processor, cause the processor to perform a method for computing a pick plan and providing pick instructions to a robotic picking unit associated with a pick area, the method comprising:
obtaining pick area data, the pick area data comprising image data and depth data associated with the pick area, the image data and depth data comprising data associated with one or more objects located at least partially in the pick area, the one or more objects capable of being at least one of picked and moved by the robotic picking unit associated with the pick area, the image data obtained from a camera system associated with the pick area, the image data comprising two dimensional image data, the depth data comprising three dimensional depth data;
automatically identifying, in the pick area data, a plurality of objects able to be at least one of picked and moved, wherein the identifying comprises differentiating each object from other objects and defining a pick shape associated with each object, wherein the pick shape is indicative of a target pick portion of the object, wherein the target pick portion of the object is associated with an area of the object to be interfaced by an end effector of the robotic picking unit;
determining at least one feature associated with each object based on the pick area data;
computing a pick plan for at least one of picking and moving one or more of the objects, the pick plan computed based on the pick shape and at least one of the features;
providing pick instructions associated with the computed pick plan to a robotic picking unit, wherein the pick instructions comprise instructions to at least one of pick and move at least one object thereby enabling the robotic picking unit to perform picking operations in accordance with the computed pick plan.
